(19) United States
(12) Patent Application Publication
(10) Pub. No.: US 2023/0382490 A1
(43) Pub. Date: Nov. 30, 2023

(54) HUMAN-POWERED VEHICLE CONTROL DEVICE, HUMAN-POWERED VEHICLE COMPONENT, AND HUMAN-POWERED VEHICLE DRIVE UNIT

(71) Applicant: Shimano Inc., Osaka (JP)

(72) Inventors: Shinichiro NODA, Sakai, Osaka (JP); Takeshi UEDA, Osaka (JP); Yuta MIZUTANI, Osaka (JP); Yuichi UEYAMA, Osaka (JP); Akihiro NOZAKI, Osaka (JP)

(21) Appl. No.: 18/197,639

(22) Filed: May 15, 2023

(30) Foreign Application Priority Data
May 31, 2022 (JP) 2022-088165

(51) Int. Cl. B62M 25/08; B62M 6/40

(52) U.S. Cl. CPC B62M 25/08; B62M 6/40

(57) ABSTRACT

A control device is provided for controlling a transmission device of a human-powered vehicle. The control device includes an electronic controller configured to control the transmission device. The electronic controller is configured to restrict actuation of the transmission device for a predetermined period from a first time after an action of the transmission device is completed. The electronic controller is configured to change the predetermined period in accordance with a traveling state of the human-powered vehicle.

### CROSS-REFERENCE TO RELATED APPLICATIONS

This application claims priority to Japanese Patent Application No. 2022-088165, filed on May 31, 2022. The entire disclosure of Japanese Patent Application No. 2022-088165 is hereby incorporated herein by reference.

### BACKGROUND

### Technical Field

The present disclosure generally relates to a human-powered vehicle control device, a human-powered vehicle component, and a human-powered vehicle drive unit.

### Background Information

Control devices are known for controlling a transmission device of a human-powered vehicle. One example of a control device for controlling a transmission device of a human-powered vehicle is disclosed in U.S. Pat. No. 9,682,744. The control device disclosed in U.S. Pat. No. 9,682,744 provides an interval between actions of the transmission device.

### SUMMARY

An objective of the present disclosure is to provide a human-powered vehicle control device, a human-powered vehicle component, and a human-powered vehicle drive unit that actuate a transmission device in a preferred manner.

A control device in accordance with a first aspect of the present disclosure is provided for controlling a transmission device of a human-powered vehicle. The control device comprises an electronic controller configured to control the transmission device. The electronic controller is configured to restrict actuation of the transmission device for a predetermined period from a first time after an action of the transmission device is completed. The electronic controller is configured to change the predetermined period in accordance with a traveling state of the human-powered vehicle.

With the control device according to the first aspect, the electronic controller restricts a shifting action for the predetermined period from the first time after an action of the transmission device is completed. This avoids shift shock. With the control device according to the first aspect, the electronic controller changes the predetermined period in accordance with the traveling state of the human-powered vehicle. Thus, the transmission device is actuated in accordance with the traveling state. The control device according to the first aspect restricts actuation of the transmission device from the first time after an action of the transmission device is completed. This avoids a situation in which the time required for performing the action of the transmission device causes the predetermined period to become an inappropriate length. Therefore, the control device actuates the transmission device in a preferred manner.

In accordance with a second aspect of the present disclosure, the control device according to the first aspect is configured so that the electronic controller is configured to change the predetermined period in accordance with the traveling state at a second time that is between initiation of an action of the transmission device and completion of the action.

With the control device according to the second aspect, the electronic controller changes the predetermined period in accordance with the traveling state during an action of the transmission device. This allows the electronic controller to restrict actuation of the transmission device in accordance with the predetermined period optimized for the traveling state.

In accordance with a third aspect of the present disclosure, the control device according to the first or second aspect is configured so that the traveling state includes a first state and a second state that differs from the first state. The electronic controller is configured to change the predetermined period so that the predetermined period becomes a first predetermined period in a case where the traveling state is the first state. The electronic controller is configured to change the predetermined period so that the predetermined period becomes a second predetermined period in a case where the traveling state is the second state. The first predetermined period is longer than the second predetermined period.

With the control device according to the third aspect, the electronic controller restricts actuation of the transmission device in accordance with the predetermined period optimized for the traveling state in each of a case where the traveling state is the first state and a case where the traveling state is the second state.

In accordance with a fourth aspect of the present disclosure, the control device according to the third aspect is configured so that the traveling state includes a rotational speed of a crank. The rotational speed of the crank in the first state includes a first crank rotational speed. The rotational speed of the crank in the second state includes a second crank rotational speed. The electronic controller is configured to change the predetermined period so that the first predetermined period becomes longer than the second predetermined period in a case where the first crank rotational speed is less than the second crank rotational speed.

With the control device according to the fourth aspect, the electronic controller restricts actuation of the transmission device for a longer period in a case where the first crank rotational speed is less than the second crank rotational speed.

In accordance with a fifth aspect of the present disclosure, the control device according to the fourth aspect is configured so that the electronic controller is configured to change the predetermined period to a first control period in a case where the rotational speed of the crank is less than or equal to a first threshold value. The first control period is a fixed period regardless of the rotational speed of the crank.

With the control device according to the fifth aspect, the electronic controller restricts actuation of the transmission device in accordance with the first control period that is fixed regardless of the rotational speed of the crank in a case where the rotational speed of the crank is less than or equal to the first threshold value.

In accordance with a sixth aspect of the present disclosure, the control device according to the fifth aspect is configured so that the electronic controller is configured to change the predetermined period to a second control period in a case where the electronic controller does not obtain information related to the rotational speed of the crank.

With the control device according to the sixth aspect, the electronic controller changes the predetermined period to the second control period in a case where the electronic controller does not obtain information related to the rotational speed of the crank. This allows the electronic controller to restrict actuation of the transmission device even if the information related to the rotational speed of the crank is not obtained.

In accordance with a seventh aspect of the present disclosure, the control device according to the sixth aspect is configured so that the second control period is equal to the first control period.

With the control device according to the seventh aspect, the electronic controller restricts actuation of the transmission device in accordance with the same predetermined period in a case where the electronic controller does not obtain information related to the rotational speed of the crank and a case where the rotational speed of the crank is less than or equal to the first threshold value.

In accordance with an eighth aspect of the present disclosure, the control device according to any one of the fourth to seventh aspects is configured so that the electronic controller is configured to change the predetermined period to a third control period in a case where the rotational speed of the crank is greater than or equal to a second threshold value. The third control period is a fixed period regardless of the rotational speed of the crank.

With the control device according to the eighth aspect, the electronic controller restricts actuation of the transmission device in accordance with the third control period that is fixed regardless of the rotational speed of the crank in a case where the rotational speed of the crank is greater than or equal to the second threshold value.

In accordance with a ninth aspect of the present disclosure, the control device according to the third aspect is configured so that the traveling state includes a rotational speed of a crank and a transmission ratio. The rotational speed of the crank in the first state includes a first crank rotational speed, and the transmission ratio in the first state includes a first transmission ratio. The rotational speed of the crank in the second state includes a second crank rotational speed, and the transmission ratio in the second state includes a second transmission ratio. The electronic controller is configured to change the predetermined period so that the first predetermined period becomes longer than the second predetermined period in a case where the first transmission ratio is equal to the second transmission ratio and the first crank rotational speed is less than the second crank rotational speed.

With the control device according to the ninth aspect, the electronic controller restricts actuation of the transmission device in accordance with the first predetermined period that is longer than the second predetermined period in a case where the first transmission ratio is equal to the second transmission ratio and the first crank rotational speed is less than the second crank rotational speed.

In accordance with a tenth aspect of the present disclosure, the control device according to the third aspect is configured so that the traveling state includes a rotational speed of a crank and a transmission stage number. The rotational speed of the crank in the first state includes a first crank rotational speed, and the transmission stage number in the first state includes a first transmission stage number. The rotational speed of the crank in the second state includes a second crank rotational speed, and the transmission stage number in the second state includes a second transmission stage number. The electronic controller is configured to change the predetermined period so that the first predetermined period becomes longer than the second predetermined period in a case where the first transmission stage number is equal to the second transmission stage number and the first crank rotational speed is less than the second crank rotational speed.

With the control device according to the tenth aspect, the electronic controller restricts actuation of the transmission device in accordance with the first predetermined period that is longer than the second predetermined period in a case where the first transmission stage number is equal to the second transmission stage number and the first crank rotational speed is less than the second crank rotational speed.

In accordance with an eleventh aspect of the present disclosure, the control device according to any one of the first to third aspects is configured so that the traveling state includes at least one of rotational speed of a crank, human torque input to the crank, force input to a pedal, transmission ratio, transmission stage number, and vehicle speed.

With the control device according to the eleventh aspect, the electronic controller restricts actuation of the transmission device in accordance with the predetermined period optimized for at least one of the rotational speed of the crank, the human torque input to the crank, the force input to the pedal, the transmission ratio, the transmission stage number, and the vehicle speed.

In accordance with a twelfth aspect of the present disclosure, the control device according to any one of the first to eleventh aspects is configured so that the action of the transmission device includes an action shifting a chain between two adjacent ones of a plurality of sprockets.

With the control device according to the twelfth aspect, the electronic controller restricts an action of the transmission device, shifting the chain between two adjacent ones of the sprockets, in accordance with the traveling state.

In accordance with a thirteenth aspect of the present disclosure, the control device according to any one of the first to twelfth aspects is configured so that the first time is a time point at which the action of the transmission device is completed.

The control device according to the thirteenth aspect restricts actuation of the transmission device for the predetermined period from a time point at which an action of the transmission device is completed.

In accordance with a fourteenth aspect of the present disclosure, the control device according to any one of the first to twelfth aspects further comprises a receiver that receives a shifting completion signal from the transmission device. Further, the first time is a time point at which the shifting completion signal is received.

With the control device according to the fourteenth aspect, the electronic controller restricts actuation of the transmission device for the predetermined period from a time point at which a shifting completion signal is received.

In accordance with a fifteenth aspect of the present disclosure, the control device according to any one of the first to fourteenth aspects is configured so that the electronic controller is configured to control the transmission device so that the transmission device is actuated in accordance with an operation performed by a user on an operating device that is operated by the user.

With the control device according to the fifteenth aspect, the electronic controller controls the transmission device so that the transmission device is actuated by an operation performed by a user on the operating device.

In accordance with a sixteenth aspect of the present disclosure, the control device according to the fifteenth aspect is configured so that the electronic controller is configured to control the transmission device so that the transmission device initiates an action as the user starts performing a first operation on the operating device. Further, the electronic controller is configured to control the transmission device so that the transmission device initiates a following action in a case where the first operation is continuously performed as the predetermined period ends.

With the control device according to the sixteenth aspect, the electronic controller controls the transmission device so that the transmission device initiates a following action in a case where the first operation is being continued as the predetermined period ends. Thus, the electronic controller controls the transmission device in accordance with the operation performed by a user.

In accordance with a seventeenth aspect of the present disclosure, the control device according to the fifteenth aspect is configured so that the electronic controller is configured to control the transmission device so that the transmission device initiates an action as the user starts performing a first operation on the operating device. Further, the controller is configured to control the transmission device so that the transmission device initiates a following action as the predetermined period ends in a case where the user starts performing a second operation on the operating device after ending the first operation and before the predetermined period ends.

With the control device according to the seventeenth aspect, the electronic controller controls the transmission device so that the transmission device initiates a following action as the predetermined period ends in a case where a user starts performing the second operation on the operating device after ending the first operation and before the predetermined period ends. Thus, the electronic controller controls the transmission device in accordance with the operation performed by a user.

In accordance with an eighteenth aspect of the present disclosure, the control device according to any one of the first to seventeenth aspects is provided separately from the transmission device.

With the control device according to the eighteenth aspect, the transmission device is controlled by the control device provided outside the transmission device.

A human-powered vehicle component in accordance with a nineteenth aspect of the present disclosure is configured to be provided to a human-powered vehicle. The human-powered vehicle component comprises the control device according to any one of the first to seventeenth aspects, and further comprises the transmission device.

The human-powered vehicle component according to the nineteenth aspect includes both the control device and the transmission device. This allows the control device to control the transmission device in a preferred manner.

A human-powered vehicle drive unit in accordance with a twentieth aspect of the present disclosure is configured to be provided to a human-powered vehicle. The human-powered vehicle drive unit comprises the control device according to any one of the first to eighteenth aspects. The human-powered vehicle drive unit further comprises a motor configured to apply a propulsion force to the human-powered vehicle.

The human-powered vehicle drive unit according to the twentieth aspect performs a shifting action in a preferred manner in the human-powered vehicle including the human-powered vehicle drive unit configured to apply a propulsion force to the human-powered vehicle.

The human-powered vehicle control device, the human-powered vehicle component, and the human-powered vehicle drive unit in accordance with the present disclosure perform a shifting action in a preferred manner.

### BRIEF DESCRIPTION OF THE DRAWINGS

Referring now to the attached drawings which form a part of this original disclosure.

FIG. 1 is a side view of a human-powered vehicle including a human-powered vehicle control device, a human-powered vehicle component, and a human-powered vehicle drive unit in accordance with a first embodiment.

FIG. 2 is a block diagram showing the electrical configuration of the human-powered vehicle control device, the human-powered vehicle component, and the human-powered vehicle drive unit shown in FIG. 1.

FIG. 3 is a flowchart illustrating a first part of a process executed by an electronic controller shown in FIG. 2 to change a predetermined period.

FIG. 4 is a flowchart illustrating a second part of the process executed by the electronic controller shown in FIG. 2 to change the predetermined period.

FIG. 5 is a flowchart illustrating a second part of a process executed by an electronic controller in accordance with a second embodiment to change a predetermined period.

FIG. 6 is a block diagram showing the electrical configuration of a human-powered vehicle control device, a human-powered vehicle component, and a human-powered vehicle drive unit of a first modified example.

FIG. 7 is a block diagram showing the electrical configuration of a human-powered vehicle control device, a human-powered vehicle component, and a human-powered vehicle drive unit of a second modified example.

FIG. 8 is a block diagram showing the electrical configuration of a human-powered vehicle control device, a human-powered vehicle component, and a human-powered vehicle drive unit of a third modified example.

FIG. 9 is a block diagram showing the electrical configuration of a human-powered vehicle control device, a human-powered vehicle component, and a human-powered vehicle drive unit of a fourth modified example.

FIG. 10 is a block diagram showing the electrical configuration of a human-powered vehicle control device, a human-powered vehicle component, and a human-powered vehicle drive unit of a fifth modified example.

FIG. 11 is a flowchart illustrating a process executed by an electronic controller of a sixth modified example to change a predetermined period.

FIG. 12 is a flowchart illustrating a process executed by an electronic controller of a seventh modified example to change a predetermined period.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

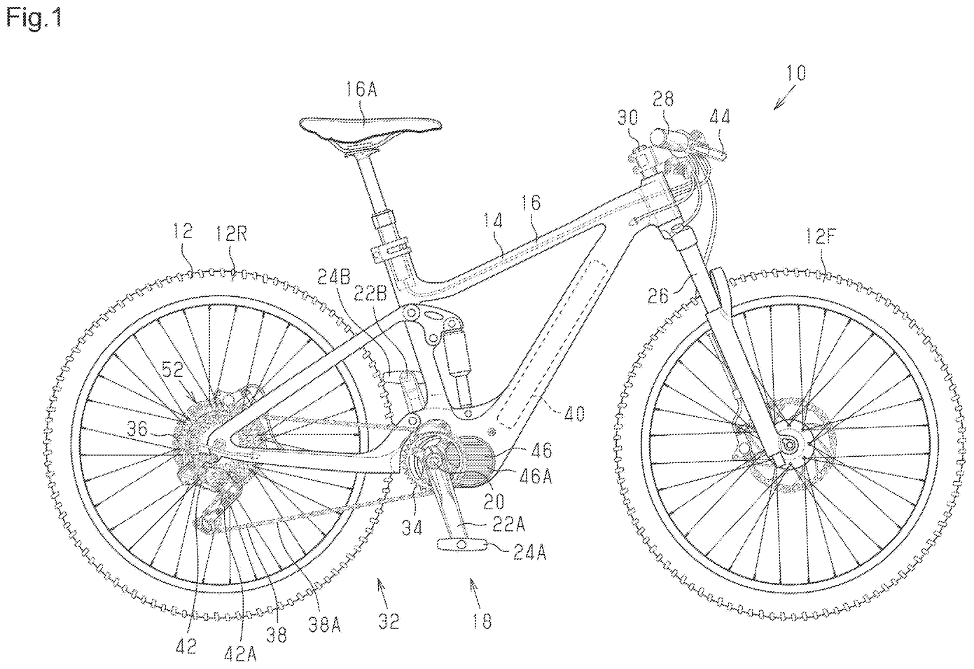

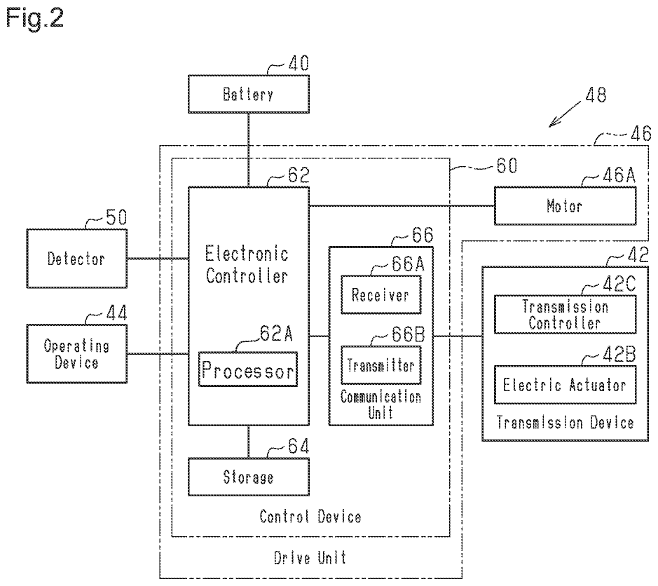

As seen in FIG. 1, a human-powered vehicle 10 is illustrated that is equipped with a drive unit 46, a human-powered vehicle component 48 and a control device 60. The drive unit 46, the human-powered vehicle component 48 and the control device 60 will now be described with reference to FIGS. 1 to 4. The human-powered vehicle 10 is a vehicle that includes at least one wheel and can be driven by at least a human driving force. Examples of human-powered vehicles that can be configured in accordance with the present disclosure include various types of bicycles such as a mountain bike, a road bike, a city bike, a cargo bike, a handcycle, and a recumbent bike. There is no limit to the number of wheels of the human-powered vehicle that can be configured in accordance with the present disclosure. The human-powered vehicle of the present disclosure also includes, for example, a unicycle or a vehicle having two or more wheels. The human-powered vehicle of the present disclosure is not limited to a vehicle that can be driven only by a human driving force. In the illustrated embodiments, the human-powered vehicle 10 includes an electric bicycle (E-bike) that uses a drive force of an electric motor for propulsion in addition to a human driving force. The E-bike includes an electric assist bicycle that assists in propulsion with an electric motor. In each embodiment described hereafter, the human-powered vehicle 10 will be described as a bicycle.

The human-powered vehicle 10 includes at least one wheel 12 and a vehicle body 14. The at least one wheel 12 includes a front wheel 12F and a rear wheel 12R. The vehicle body 14 includes a frame 16. For example, a saddle 16A is attached to the frame 16. The human-powered vehicle 10 further includes, for example, a crank 18 to which a human driving force is input. The crank 18 includes, for example, a crank axle 20 and two crank arms 22A and 22B. The crank axle 20 is rotatable relative to the frame 16. The two cranks arms 22A and 22B are provided on, for example, two axial ends of the crank axle 20, respectively. For example, two pedals 24A and 24B are coupled to the crank arms 22A and 22B, respectively.

A front fork 26 is connected to the frame 16. The front wheel 12F is attached to the front fork 26. A handlebar 28 is coupled to the front fork 26 by a stem 30. The rear wheel 12R is supported by the frame 16. In the present embodiment, the crank 18 is connected to the rear wheel 12R by a drive mechanism 32. For example, the rear wheel 12R is driven by rotation of the crank axle 20. At least one of the front wheel 12F and the rear wheel 12R can be connected to the crank 18 by the drive mechanism 32.

The drive mechanism 32 includes, for example, at least one first rotational body 34 coupled to the crank axle 20. The at least one first rotational body 34 includes, for example, at least one front sprocket. The first rotational body 34 can include a pulley or a bevel gear. The crank axle 20 can be coupled to the at least one front sprocket by a one-way clutch.

The drive mechanism 32 further includes at least one second rotational body 36 and a transferring member 38. The transferring member 38 is configured to transmit the rotational force of the at least one first rotational body 34 to the at least one second rotational body 36. The transferring member 38 includes, for example, a chain 38A. The transferring member 38 can include a belt or a shaft. The at least one second rotational body 36 includes, for example, at least one rear sprocket. The at least one second rotational body 36 can include a pulley or a bevel gear. The chain 38A is wound around, for example, one of the at least one front sprocket and one of the at least one rear sprocket. The at least one second rotational body 36 is coupled to, for example, the rear wheel 12R. The rear wheel 12R is, for example, configured to be rotated as the at least one second rotational body 36 rotates.

The human-powered vehicle 10 further includes, for example, a battery 40. The battery 40 includes, for example, one or more battery cells. Each battery cell includes, for example, a rechargeable battery. The battery 40 is configured to supply electric power to, for example, the control device 60. The battery 40 is connected to, for example, the control device 60 in a manner allowing for wired communication or wireless communication. The battery 40 is configured to perform communication with the control device 60 through, for example, power line communication (PLC). The battery 40 can be configured to perform communication with the control device 60 through Controller Area Network (CAN) or universal asynchronous receiver/transmitter (UART).

The human-powered vehicle 10 further includes, for example, a transmission device 42. The transmission device 42 is, for example, provided in a transmission path of the human driving force in the human-powered vehicle 10 and is configured to change a transmission ratio R. The transmission ratio R is, for example, a ratio of a rotational speed W of the wheel 12 to a rotational speed C of the crank 18. The rotational speed W of the wheel 12 includes, for example, the rotational speed of the drive wheel.

In the present embodiment, the drive wheel is the rear wheel 12R. The rotational speed W of the wheel 12 and the rotational speed C of the crank 18 can each be the number of rotations per unit time. In the transmission ratio R, the rotational speed W of the wheel 12 can be replace by the number of teeth in one of the at least one first rotational body 34, and the rotational speed C of the crank 18 can be replaced by the number of teeth in one of the at least one second rotational body 36. The at least one rear sprocket includes, for example, one rear sprocket engaged with the transferring member 38. The engaged rear sprocket is, for example, a rear sprocket of the at least one rear sprocket around which the chain 38A is wound. The at least one front sprocket includes, for example, one front sprocket engaged with the transferring member 38. The engaged front sprocket is, for example, a front sprocket of the at least one front sprocket around which the chain 38A is wound. The transmission ratio R can be a ratio of the number of teeth TF of the engaged front sprocket to the number of teeth of the engaged rear sprocket. The relationship of the transmission ratio R, the rotational speed W of the wheel 12, and the rotational speed C of the crank 18 satisfies the following expression (1).

R=W/C Expression (1):

The transmission device 42 includes, for example, at least one of a derailleur 42A and an internal transmission device. The derailleur 42A includes, for example, at least one of a front derailleur and a rear derailleur. For example, the derailleur 42A moves the transferring member 38 engaged with one of the sprockets 52 to another one of the sprockets 52. In a case where the transmission device 42 includes an internal transmission device, the internal transmission device is provided in, for example, a hub of the rear wheel 12R. The internal transmission device can include a continuously variable transmission (CVT). The transmission device 42 includes, for example, an electric actuator 42B. The electric actuator 42B is configured to actuate, for example, the transmission device 42. The electric actuator 42B is configured to actuate, for example, the derailleur 42A.

The transmission device 42 includes, for example, multiple transmission stages. For example, the transmission stages differ from one another in the transmission ratio R. For example, the transmission ratio R increases as the transmission stage number increases. In a case where the smallest transmission stage is selected, the transmission ratio R is the smallest transmission ratio R obtainable by the transmission device 42. In a case where the largest transmission stage is selected, the transmission ratio R is the largest transmission ratio R obtainable by the transmission device 42. The transmission stage is changed in a case where, for example, the derailleur 42A operates the transferring member 38 to change the engagement state between the transferring member 38 and the sprockets 52.

In a case where the derailleur 42A includes a rear derailleur, the sprocket 52 having the most teeth among the sprockets 52 corresponds to, for example, the smallest transmission stage obtainable by the derailleur 42A. In a case where the derailleur 42A includes a rear derailleur, the sprocket 52 having the least teeth among the sprockets 52 corresponds to, for example, the largest transmission stage obtainable by the derailleur 42A.

In a case where the derailleur 42A includes a rear derailleur, the sprockets 52 include a plurality of rear sprockets. The number of rear sprockets is, for example, three or greater and thirty or less. In a case where the derailleur 42A includes a rear derailleur, the number of transmission stages is equal to, for example, the number of the rear sprockets.

In a case where the derailleur 42A includes a front derailleur, the sprocket 52 having the most teeth among the sprockets 52 corresponds to, for example, the largest transmission stage obtainable by the derailleur 42A. In a case where the derailleur 42A includes a front derailleur, the sprocket 52 having the least teeth among the sprockets 52 corresponds to, for example, the smallest transmission stage obtainable by the derailleur 42A.

In a case where the derailleur 42A includes a front derailleur, the sprockets 52 include a plurality of front sprockets. The number of front sprockets is, for example, two or greater and four or less. In a case where the derailleur 42A includes a front derailleur, the number of transmission stages is equal to, for example, the number of the front sprockets.

The human-powered vehicle 10 further includes, for example, an operating device 44. The operating device 44 is operated by, for example, a user. The operating device 44 receives, for example, an operation performed by a user. The operating device 44 includes, for example, an operating portion configured to operate the transmission device 42. The operating portion includes at least one of a switch, a lever, and a dial.

The human-powered vehicle 10 further includes, for example, the human-powered vehicle drive unit 46. The human-powered vehicle drive unit 46 is, for example, configured to apply a propulsion force to the human-powered vehicle 10. The human-powered vehicle drive unit 46 includes, for example, a motor 46A that applies a propulsion force to the human-powered vehicle 10 in accordance with the human driving force input to the human-powered vehicle 10. The motor 46A is, for example, a brushless electric motor. The human-powered vehicle drive unit 46 will hereinafter be referred to as the “drive unit 46” for the sake of brevity.

The human-powered vehicle component 48 includes, for example, at least one of the battery 40, the transmission device 42, the operating device 44, the drive unit 46, and the control device 60. In the present embodiment, the human-powered vehicle component 48 includes the drive unit 46 and the control device 60. The drive unit 46 includes, for example, the control device 60. The control device 60 is provided, for example, separately from the transmission device 42. The control device 60 is provided in, for example, a cavity inside a housing of the drive unit 46.

The human-powered vehicle control device 60 includes an electronic controller 62. The electronic controller 62 includes, for example, at least one processor 62A that executes predetermined control programs. The processors include, for example, a central processing unit (CPU) or a micro-processing unit (MPU). The electronic controller 62 can include one or more microcomputers located at separate positions. The electronic controller 62 can include more than one processor located at separate positions. The electronic controller 62 will hereinafter be referred to as the “controller 62” for the sake of brevity. The terms “controller” and “electronic controller” as used herein refer to hardware that executes a software program, and does not include a human being.

The control device 60 further includes, for example, memory or storage 64. The storage 64 stores, for example, control programs and information used for control processes. The storage 64 includes, for example, at least one of a nonvolatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM). The storage 64 is, for example, electrically connected to the controller 62 through wired communication or wireless communication. Thus, the terms “memory” and “storage” as used herein refer to any computer storage device or any non-transitory computer-readable medium with the sole exception of a transitory, propagating signal. In other words, the terms “memory” and “storage” as used herein refers to a non-transitory computer readable memory.

The control device 60 further includes, for example, a receiver 66A. The control device 60 further includes, for example, a transmitter 66B. The control device 60 further includes, for example, a communication unit 66 including at least one of the receiver 66A and the transmitter 66B. Thus, the term “communication unit” as used herein refers to hardware that is configured to transmit and/or receive signals, and does not include a human being. The communication unit 66 is, for example, electrically connected to the controller 62 through wired communication or wireless communication. The communication unit 66 is, for example, electrically connected to the transmission device 42 through wired communication or wireless communication.

The receiver 66A receives, for example, a shifting completion signal from the transmission device 42. The controller 62 is, for example, configured to control the receiver 66A so that the receiver 66A receives a shifting completion signal from the transmission device 42. In an example in which a shifting completion signal is received from the transmission device 42, the controller 62 determines that an action of the transmission device 42 is completed. The transmitter 66B transmits, for example, a shifting initiation signal to the transmission device 42. The controller 62 is, for example, configured control the transmitter 66B so that the transmitter 66B transmits a shifting initiation signal to the transmission device 42. In an example in which the transmission device 42 receives a shifting initiation signal, the transmission device 42 initiates actuation of the electric actuator 42B.

The control device 60 can further include a drive circuit of the motor 46A. The drive circuit of the motor 46A is provided on, for example, the drive unit 46. The drive circuit of the motor 46A is arranged in, for example, the cavity inside the housing of the drive unit 46. The drive circuit of the motor 46A is, for example, electrically connected to the controller 62 through wired communication or wireless communication. The drive circuit of the motor 46A drives the motor 46A in response to, for example, a control signal from the controller 62.

The drive circuit of the motor 46A is, for example, configured to control the supply of electric power from the battery 40 to the motor 46A. The drive circuit of the motor 46A includes, for example, an inverter circuit. The inverter circuit includes, for example, transistors. The inverter circuit has, for example, a configuration in which inverter units are connected to one another in parallel. Each inverter unit is formed by two transistors connected in series. The inverter circuit can include a current sensor configured to detect the current flowing through the inverter circuit. The current sensor is, for example, electrically connected to the controller 62 through wired communication or wireless communication.

The human-powered vehicle 10 further includes, for example, a detector 50. The term “detector” as used herein refers to a hardware device or instrument designed to detect the presence or absence of a particular event, object, substance, or a change in its environment, and to emit a signal in response. The term “detector” as used herein does not include a human being. The detector 50 is configured to detect a traveling state of the human-powered vehicle 10. The traveling state includes, for example, at least one of the rotational speed C of the crank 18, a human torque input to the crank 18, a force input to the pedal 24A, 24B, the transmission ratio R, the transmission stage number, and a vehicle speed. The detector 50 includes, for example, at least one of a human driving force detector, a crank rotational state detector, a vehicle speed detector, and a transmission state detector. The detector 50 is, for example, electrically connected to the controller 62 through wired communication or wireless communication. The human driving force includes at least one of the human torque input to the crank 18 and the force input to the pedal 24A, 24B. A crank rotational state includes the rotational speed C of the crank 18. A transmission state includes at least one of an actuation state of the transmission device 42 corresponding to at least one of the transmission ratio R and the transmission stage number, and an actuation state of the operating device 44 corresponding to at least one of the transmission ratio R and the transmission stage number.

The human driving force detector is provided on, for example, the drive unit 46. The human driving force detector is arranged in, for example, the cavity inside the housing of the drive unit 46. The human driving force detector is provided on, for example, a member included in the transmission path of the human driving force. The member included in the transmission path of the human driving force includes, for example, a member rotated in cooperation with the crank axle 20 or the crank axle 20.

The human driving force detector is, for example, configured to output a signal corresponding to the torque applied to the crank axle 20 by a human driving force. The signal corresponding to the torque applied to the crank axle 20 by the human driving force includes information related to the human driving force input to the crank 18. The human driving force detector includes, for example, a strain sensor, a magnetostrictive sensor, or a pressure sensor. The strain sensor includes, for example, a strain gauge. The human driving force detector can have any configuration as long as information related to the human driving force is obtained.

The human driving force detector does not have to be provided on the drive unit 46. The human driving force detector can be provided on the crank arm 22A, 22B or the pedal 24A, 24B. In a case where the human driving force detector is provided on the pedal 24A, 24B, the human driving force detector can include a sensor that detects the pressure applied to the pedal 24A, 24B. The human driving force detector can be provided on the chain 38A. In a case where the human driving force detector is provided on the chain 38A, the human driving force detector can include a sensor that detects the tension on the chain 38A.

The crank rotational state detector is provided on, for example, the drive unit 46. The crank rotational state detector is arranged in, for example, the cavity formed in the housing of the drive unit 46. The crank rotational state detector is configured to detect information corresponding to the rotational speed C of the crank 18. The information corresponding to the rotational speed C of the crank 18 includes, for example, an angular acceleration of the crank axle 20. The angular acceleration of the crank axle 20 corresponds to, for example, the acceleration of the human-powered vehicle 10. The information corresponding to the rotational speed C of the crank 18 includes, for example, information related to cadence of the human-powered vehicle 10.

The crank rotational state detector includes, for example, at least one of a magnetic sensor, an acceleration sensor, an optical sensor, a gyro sensor, and a torque sensor. The crank rotational state detector includes, for example, a magnetic sensor that outputs a signal corresponding to the strength of a magnetic field. The magnetic sensor includes, for example, a ring-shaped magnet of which the magnetic field changes in a circumferential direction. The ring-shaped magnet of which the magnetic field changes in the circumferential direction is provided on, for example, a member included in the transmission path of the human driving force. The member included in the transmission path of the human driving force includes, for example, a member rotated in cooperation with the crank axle 20 or the crank axle 20. The crank rotational state detector outputs, for example, a signal corresponding to the rotational speed C of the crank 18.

The crank rotational state detector can include an acceleration sensor instead of the magnetic sensor. The crank rotational state detector can include an optical sensor, a gyro sensor, or a torque sensor instead of the magnetic sensor. The crank rotational state detector can have any configuration as long as information corresponding to the rotational speed C of the crank 18 is obtained.

The crank rotational state detector is, for example, configured to output a predetermined number of detection signals during a period in which the crank axle 20 completes one rotation. The predetermined number is, for example, two or greater. The predetermined number is, for example, four or greater. The predetermined number is, for example, a multiple of four. The predetermined number is, for example, eight, twelve, or sixteen.

The crank rotational state detector does not have to be provided on the drive unit 46. The crank rotational state detector is provided on, for example, the frame 16. In a case where the crank rotational state detector is not provided on the drive unit 46, the crank rotational state detector can include a vehicle speed sensor. In an example in which the crank rotational state detector includes a vehicle speed sensor, the controller 62 is configured to calculate the rotational speed C of the crank 18 from the vehicle speed detected by the vehicle speed sensor and the transmission ratio R.

The vehicle speed detector is provided on, for example, the frame 16. The vehicle speed detector is, for example, configured to detect information related to the speed of the human-powered vehicle 10. The vehicle speed detector is, for example, configured to detect information related to the rotational speed W of the wheel 12 of the human-powered vehicle 10. The vehicle speed detector is, for example, configured to detect a magnet provided on at least one of the front wheel 12F and the rear wheel 12R.

The vehicle speed detector is, for example, configured to output a predetermined number of detection signals during a period in which the wheel 12 completes one rotation. The predetermined number is, for example, one. The vehicle speed detector outputs, for example, a signal corresponding to the rotational speed W of the wheel 12. The controller 62 is configured to calculate the speed of the human-powered vehicle 10 based on, for example, a signal corresponding to the rotational speed W of the wheel 12 and information related to the circumferential length of the wheel 12. For example, the storage 64 stores the information related to the circumferential length of the wheel 12.

The transmission state detector is provided on, for example, the transmission device 42. The transmission state detector is configured to detect information related to a present transmission stage number.

The transmission state detector includes, for example, a sensor that outputs a signal in accordance with actuation of the electric actuator 42B. The transmission state detector can include at least one of a magnetic sensor, an optical sensor, and a potentiometer.

In a case where the transmission device 42 includes the derailleur 42A, information related to the present transmission stage number includes, for example, the position of a movable member of the derailleur 42A with respect to the frame 16, a rotational phase of the movable member, and information related to actuation of the electric actuator 42B. The movable member includes, for example, a chain guide. In a case where the transmission state detector detects at least one of the position of the movable member with respect to the frame 16 and the rotational phase of the movable member, the transmission state detector detects, for example, the magnetic force of a magnet provided on one of the frame 16 or the movable member to obtain at least one of the position of the movable member with respect to the frame 16 and the rotational phase of the movable member.

Information related to actuation of the electric actuator 42B can include the rotational speed of the electric actuator 42B detected by a magnetic sensor. In a case where the transmission state detector detects the rotational speed of the electric actuator 42B, the transmission state detector detects, for example, the rotational speed of the rotational shaft of the electric actuator 42B. The derailleur 42A can further include a speed reducer connected to the electric actuator 42B. The speed reducer includes a number of gears. In a case where the derailleur 42A includes a speed reducer, the information related to actuation of the electric actuator 42B can include a rotational speed of the gear included in the speed reducer. In a case where the transmission state detector detects the rotational speed of the gear included in the speed reducer, the transmission state detector detects, for example, the magnetic force of a magnet provided on the gear of the speed reducer.

The transmission device 42 can include a transmission controller 42C. The transmission controller 42C includes, for example, at least one processor that execute predetermined control programs. The processors include, for example, a CPU or an MPU. The transmission controller 42C can include one or more microcomputers located at separate positions. The transmission controller 42C can include more than one processor located at separate positions. The transmission controller 42C can further include, for example, transmission storage. The transmission storage stores, for example, control programs and information used for control processes. The transmission storage includes, for example, at least one of a nonvolatile memory and a volatile memory (i.e., a non-transitory computer readable memory). The transmission storage does not include a transitory, propagating signal. The non-volatile memory includes, for example, at least one of a ROM, an EPROM, an EEPROM, and a flash memory. The volatile memory includes, for example, a RAM.

The transmission controller 42C can use, for example, the information related to the present transmission stage number detected by the transmission state detector to determine that shifting of the transmission ratio R has been completed, and then output a shifting completion signal to the controller 62. In a case where the transmission controller 42C receives a shifting initiation signal from the controller 62, the transmission controller 42C drives the electric actuator 42B to initiate shifting of the transmission ratio R. The transmission state detector transmits, for example, a detection signal to the transmission controller 42C in fixed time intervals. In an example in which the transmission controller 42C receives a shifting initiation signal from the controller 62, the transmission controller 42C obtains a detection signal transmitted from the transmission state detector. For example, as the transmission controller 42C determines that shifting is completed based on the detection signal transmitted from the transmission state detector, the transmission controller 42C transmits a shifting completion signal to the controller 62.

The controller 62 can obtain a detection signal transmitted from the transmission state detector. The controller 62 can receive a detection signal of the transmission state detector and use the signal to determine whether the transmission ratio R has been changed. The controller 62 can use the rotational speed C of the crank 18 and the rotational speed W of the wheel 12 to determine whether the transmission ratio R has been changed. The controller 62 can be configured to calculate the transmission ratio R from the rotational speed C of the crank 18 and the rotational speed W of the wheel 12 in a case where the human driving force is greater than or equal to a predetermined threshold value.

The controller 62 is, for example, configured to control the motor 46A. The controller 62 is, for example, configured to control the motor 46A in accordance with the traveling state of the human-powered vehicle 10. The controller 62 is, for example, configured to control the motor 46A so that the propulsion force applied to the human-powered vehicle 10 is changed in accordance with the human driving force input to the human-powered vehicle 10.

The controller 62 can be configured to control the motor 46A so that output of the motor 46A is decreased during an action of the transmission device 42. The controller 62 can be configured to control the motor 46A so that the motor 46A is stopped during the action of the transmission device 42. The controller 62 can be configured to control the motor 46A so that the output of the motor 46A is decreased during an action of the transmission device 42 and so that the propulsion force applied to the human-powered vehicle 10 is changed in accordance with the human driving force input to the human-powered vehicle 10 for a predetermined period Y from a first time.

The controller 62 can be configured to control the motor 46A in accordance with the human driving force detected by the human driving force detector. The controller 62 can be configured to control the motor 46A in accordance with the rotational speed C of the crank 18 detected by the crank rotational state detector. The controller 62 can be configured to control the motor 46A in accordance with the rotational speed W of the wheel 12 detected by the vehicle speed detector. The controller 62 can be configured to control the motor 46A in accordance with information transmitted from outside the drive unit 46. The information transmitted from outside the drive unit 46 includes, for example, an operation signal from a drive unit operating device configured to operate the drive unit 46.

The controller 62 is configured to control the transmission device 42. The controller 62 is, for example, configured to control the transmission device 42 so that the transmission device 42 is actuated in accordance with an operation performed by a user on the operating device 44. The controller 62 is, for example, configured to control the transmission device 42 so that the transmission device 42 initiates an action as the user starts performing a first operation on the operating device 44.

The controller 62 is configured to restrict actuation of the transmission device 42 for the predetermined period Y from the first time after an action of the transmission device 42 is completed. The controller 62 is, for example, configured to control the transmission device 42 so that the transmission device 42 initiates a following action in a case where the first operation is continuously performed as the predetermined period Y ends. A case where the first operation is continuously performed includes, for example, a case where the operating device 44 is continuously pressed by the user. In a case in which the operating portion of the operating device 44 includes a switch, a case where the operating device 44 is continuously operated by the user includes, for example, a case where the switch is continuously pressed by the user. In a case in which the operating portion of the operating device 44 includes a lever, a case where the operating device 44 is continuously operated by the user includes, for example, a case where the lever is maintained at a predetermined position by the user.

An action of the transmission device 42 includes, for example, an action performed by the derailleur 42A to operate the transferring member 38 so as to change the transmission ratio R. An action of the transmission device 42 includes, for example, an action shifting the chain 38A between two adjacent ones of the sprockets 52. An action of the transmission device 42 includes a shifting-up action performed by the derailleur 42A. An action of the transmission device 42 includes a shifting-down action performed by the derailleur 42A.

The controller 62 can control the transmission device 42 so that the transmission device 42 executes inching control in a case where the transmission device 42 is actuated. The inching control includes a control executed after an action of the transmission device 42 is completed in a case where a detection value of the rotational speed of the electric actuator 42B or a detection value of the rotational speed of the gear included in the speed reducer obtained by the transmission state detector differs from a specified value that is stored in advance. The inching control is executed to further actuate the electric actuator 42B so as to reduce the difference.

The first time is, for example, a time point based on an action of the transmission device 42. The first time is, for example, a time point at which an action of the transmission device 42 is completed. The first time is, for example, a time point at which a shifting completion signal is received. The first time does not have to be a time point at which an action of the transmission device 42 is completed as long as the first time is in the predetermined period Y after the action of the transmission device 42 is completed. In a case where the controller 62 controls the transmission device 42 so that the transmission device 42 executes inching control, the inching control can be executed for the predetermined period Y after an action of the transmission device 42 is completed.

The predetermined period Y is, for example, a period during which the controller 62 controls the transmission device 42 so that the transmission device 42 is not actuated. For example, the controller 62 prohibits actuation of the transmission device 42 in the predetermined period Y. The predetermined period Y is, for example, a period that is changed in accordance with the traveling state of the human-powered vehicle 10. The predetermined period Y is determined by, for example, time. The predetermined period Y does not have to be determined by time. In a case where the predetermined period Y is not determined by time, the predetermined period Y can be determined by at least one of a rotational angle of the crank 18, a rotational angle of the at least one first rotational body 34, and a rotational angle of the at least one second rotational body 36.

The controller 62 is configured to change the predetermined period Y in accordance with the traveling state of the human-powered vehicle 10. The controller 62 is, for example, configured to change the predetermined period Y in accordance with the traveling state at a second time that is between initiation of an action of the transmission device 42 and completion of the action. The controller 62 can change the predetermined period Y in accordance with the traveling state at a time point at which an action of the transmission device 42 is completed.

The traveling state includes a first state and a second state that differs from the first state. The controller 62 is configured to change the predetermined period Y so that the predetermined period Y becomes a first predetermined period in a case where the traveling state is the first state. The controller 62 is configured to change the predetermined period Y so that the predetermined period Y becomes a second predetermined period in a case where the traveling state is the second state. The first predetermined period is longer than the second predetermined period. In a case where the first state is any single traveling state, the second state can be any other traveling state that differs from the first state. In a case where the first state is any single traveling state, the second state can be any other traveling state if, for example, the comparison of the first and second states satisfies a predetermined relationship. The first state can include more than one traveling state. The second state can include more than one traveling state.

The traveling state includes, for example, the rotational speed C of the crank 18. The rotational speed C of the crank 18 in the first state includes a first crank rotational speed. The rotational speed C of the crank 18 in the second state includes a second crank rotational speed. The first crank rotational speed differs from the second crank rotational speed. In a case where the first crank rotational speed is a certain rotational speed C of the crank 18, the second crank rotational speed can be any rotational speed C of the crank 18 that differs from the first crank rotational speed. In a case where the first crank rotational speed is a certain rotational speed C of the crank 18, the second crank rotational speed can be any rotational speed C of the crank 18, for example, less than the first crank rotational speed. The first crank rotational speed can include more than one first crank rotational speed. The second crank rotational speed can include more than one second crank rotational speed. The first crank rotational speed can correspond to the rotational speed C of the crank 18 included in a first range. The second crank rotational speed can correspond to the rotational speed C of the crank 18 included in a second range that differs from the first range.

The second predetermined period is, for example, a period obtained by multiplying a ratio of the second crank rotational speed to the first crank rotational speed by the first predetermined period. The controller 62 is, for example, configured to change the predetermined period Y so that the first predetermined period becomes longer than the second predetermined period in a case where the first crank rotational speed is less than the second crank rotational speed. The controller 62 can be, for example, configured to change the predetermined period Y so that the first predetermined period becomes shorter than the second predetermined period in a case where the first crank rotational speed is greater than the second crank rotational speed.

The traveling state includes, for example, the rotational speed C of the crank 18 and the transmission ratio R. For example, the rotational speed C of the crank 18 in the first state includes the first crank rotational speed, and the transmission ratio R in the first state includes a first transmission ratio. For example, the rotational speed C of the crank 18 in the second state includes the second crank rotational speed, and the transmission ratio R in the second state includes a second transmission ratio.

The controller 62 is, for example, configured to change the predetermined period Y so that the first predetermined period becomes longer than the second predetermined period in a case where the first transmission ratio is equal to the second transmission ratio and the first crank rotational speed is less than the second crank rotational speed. The controller 62 can be, for example, configured to change the predetermined period Y so that the first predetermined period becomes shorter than the second predetermined period in a case where the first transmission ratio is equal to the second transmission ratio and the first crank rotational speed is greater than the second crank rotational speed.

The controller 62 is, for example, configured to change the predetermined period Y so that the first predetermined period becomes longer than the second predetermined period in a case where the first transmission ratio is less than the second transmission ratio and the first crank rotational speed is equal to the second crank rotational speed. The controller 62 can be, for example, configured to change the predetermined period Y so that the first predetermined period becomes shorter than the second predetermined period in a case where the first transmission ratio is greater than the second transmission ratio and the first crank rotational speed is equal to the second crank rotational speed.

The traveling state includes, for example, the rotational speed C of the crank 18 and the transmission stage number. For example, the rotational speed C of the crank 18 in the first state includes the first crank rotational speed, and the transmission stage number in the first state includes a first transmission number. For example, the rotational speed C of the crank 18 in the second state includes the second crank rotational speed, and the transmission stage number in the second state includes a second transmission number.

The controller 62 is, for example, configured to change the predetermined period Y so that the first predetermined period becomes longer than the second predetermined period in a case where the first transmission number is equal to the second transmission number and the first crank rotational speed is less than the second crank rotational speed. The controller 62 can be, for example, configured to change the predetermined period Y so that the first predetermined period becomes shorter than the second predetermined period in a case where the first transmission number is equal to the second transmission number and the first crank rotational speed is greater than the second crank rotational speed.

The controller 62 is, for example, configured to change the predetermined period Y so that the first predetermined period becomes longer than the second predetermined period in a case where the first transmission number is less than the second transmission number and the first crank rotational speed is equal to the second crank rotational speed. The controller 62 can be, for example, configured to change the predetermined period Y so that the first predetermined period becomes shorter than the second predetermined period in a case where the first transmission number is greater than the second transmission number and the first crank rotational speed is equal to the second crank rotational speed.

In a case where the controller 62 determines the predetermined period Y in accordance with the traveling state, the controller 62 calculates the rotational speed of the rear wheel 12R and the rotational speed of the rear sprocket from, for example, the vehicle speed and the transmission stage number. For example, the controller 62 uses the rotational speed of the rear sprocket to calculate a length of time during which the rear sprocket will be rotated until the rotational phase of the rear sprocket reaches a rotational phase corresponding to a shifting facilitation region of the rear sprocket. A rotational phase corresponding to the shifting facilitation region of the rear sprocket is, for example, a rotational phase at which the chain 38A engages the sprocket teeth included in the shifting facilitation region of the rear sprocket. The controller 62 determines the predetermined period Y in accordance with, for example, the length of time required by the rear sprocket to reach the rotational phase corresponding to the shifting facilitation region of the rear sprocket. The controller 62 can determine the predetermined period Y in accordance with the rotational speed of the rear sprocket and an amount of rotation required by the rear sprocket to reach the rotational phase corresponding to the shifting facilitation region of the rear sprocket.

The controller 62 can use, for example, the rotational speed C of the crank 18 and one of the transmission ratio R and the transmission stage number to calculate a length of time during which the rear sprocket will be rotated until the rotational phase of the rear sprocket reaches the rotational phase corresponding to the shifting facilitation region of the rear sprocket. The controller 62 can be configured to determine the predetermined period Y in accordance with the rotational speed C of the crank 18 and a table indicating the predetermined period Y in combination of the transmission ratio R or the transmission stage number. For example, the storage 64 stores the table indicating the predetermined period Y in combination of the transmission ratio R or the transmission stage number.

In a case where the derailleur 42A includes a rear derailleur, the predetermined period Y is, for example, a period during which the relationship of the rotational speed C of the crank 18, the number of teeth TF of the front sprocket, and the number of teeth TW within the shifting facilitation region of the rear sprocket satisfies the following expression (2).

Y≥TW/{(C/60)·TF} Expression (2):

The shifting facilitation region is, for example, a region that extends in a circumferential direction of the rear sprockets. Shifting of the chain 38A is facilitated in the shifting facilitation region as compared to outside of the region. In a case where the at least one second rotational body 36 includes multiple rear sprockets, each rear sprocket includes, for example, at least one shifting facilitation region. Each of the rear sprockets includes, for example, a different number of shifting facilitation regions. Each of the rear sprockets can include, for example, the same number of shifting facilitation regions.

In an example in which the transmission ratio R is increased, the number of teeth TW within the shifting facilitation region of the rear sprocket corresponds to the number of teeth TW within the shifting facilitation region of the rear sprocket to which the chain 38A is shifted. In an example in which the transmission ratio R is decreased, the number of teeth TW within the shifting facilitation region of the rear sprocket corresponds to the number of teeth TW within the shifting facilitation region of the rear sprocket from which the chain 38A is shifted.

In a case where more than one first rotational body 34 includes more than one front sprocket, each front sprocket can include at least one shifting facilitation region. In a case where the derailleur 42A includes a front derailleur, the number of teeth TF of the rear sprocket can be replaced by the number of teeth of the front sprocket, and the number of teeth TW within the shifting facilitation region of the rear sprocket can be replaced by the number of teeth within the shifting facilitation region of the front sprocket.

In a case where the controller 62 changes the predetermined period Y, the controller 62 can change the predetermined period Y in a linear manner in accordance with the traveling state. In a case where the controller 62 uses, for example, expression (2) to change the predetermined period Y, the controller 62 can change the predetermined period Y in a linear manner in accordance with the traveling state. The controller 62 can change the predetermined period Y in a stepped manner in accordance with the traveling state. In a case where the controller 62 changes the predetermined period Y in a stepped manner in accordance with the traveling state, the controller 62 can use a predetermined threshold value related to the traveling state to change the predetermined period Y.

The controller 62 can be configured to change the predetermined period Y in accordance with whether the rotational speed C of the crank 18 is greater than or equal to the predetermined threshold value. The controller 62 can be, for example, configured to change the predetermined period Y in accordance with whether the rotational speed C of the crank 18 is greater than the predetermined threshold value. The controller 62 can be, for example, configured to change the predetermined period Y in accordance with whether the human torque input to the crank 18, instead of the rotational speed C of the crank 18, is greater than or equal to the predetermined threshold value. The controller 62 can be, for example, configured to change the predetermined period Y in accordance with whether the human torque input to the crank 18, instead of the rotational speed C of the crank 18, is greater than the predetermined threshold value. The controller 62 can be, for example, configured to change the predetermined period Y in accordance with whether the force input to the pedal 24A, 24B, instead of the rotational speed C of the crank 18, is greater than or equal to the predetermined threshold value. The controller 62 can be, for example, configured to change the predetermined period Y in accordance with whether the force input to the pedal 24A, 24B, instead of the rotational speed C of the crank 18, is greater than the predetermined threshold value.

The controller 62 is configured to change the predetermined period Y to a first control period in an example in which the rotational speed C of the crank 18 is less than or equal to a first threshold value. The first control period is, for example, a fixed period regardless of the rotational speed C of the crank 18. In an example in which the rotational speed C of the crank 18 is less than or equal to the first threshold value, the first control period corresponds to a fixed period regardless of the rotational speed C of the crank 18. The controller 62 uses, for example, expression (2) to set the predetermined period Y to the first control period. The controller 62 sets the predetermined period to the first control period in an example in which a value calculated at the right side of expression (2) is greater than the first control period. In a case where the rotational speed C of the crank 18 is less than or equal to the first threshold value, the controller 62 can be configured to set the predetermined period Y to the first control period rather than the value obtained by expression (2). In an example in which the rotational speed C of the crank 18 is less than or equal to the first threshold value, the controller 62 changes the predetermined period Y to the first control period without calculating expression (2). In a case where the controller 62 uses the predetermined threshold value related to the traveling state to change the predetermined period Y, it is preferred that the first threshold value be less than the predetermined threshold value.

The controller 62 is configured to change the predetermined period Y to a second control period in an example in which the controller 62 does not obtain information related to the rotational speed C of the crank 18. The second control period is, for example, equal to the first control period. The second control period can differ from the first control period. In a case where the controller 62 does not obtain information related to the rotational speed C of the crank 18, the controller 62 can be configured to set the predetermined period Y to the second control period rather than the predetermined period Y obtained by expression (2). In an example in which the controller 62 does not obtain information related to the rotational speed C of the crank 18, the controller 62 changes the predetermined period Y to the second control period without calculating expression (2).

The controller 62 is configured to change the predetermined period Y to a third control period in an example in which the rotational speed C of the crank 18 is greater than or equal to a second threshold value. The predetermined period Y is set to, for example, the third control period rather than the predetermined period Y obtained by expression (2). The second threshold value is, for example, greater than the first threshold value. In a case where the controller 62 uses the predetermined threshold value related to the traveling state to change the predetermined period Y, it is preferred that the second threshold value be greater than the predetermined threshold value. The third control period is, for example, a fixed period regardless of the rotational speed C of the crank 18. In an example in which the rotational speed C of the crank 18 is greater than or equal to the second threshold value, the third control period corresponds to a fixed period regardless of the rotational speed C of the crank 18. The third control period is, for example, shorter than the first control period and the second control period.

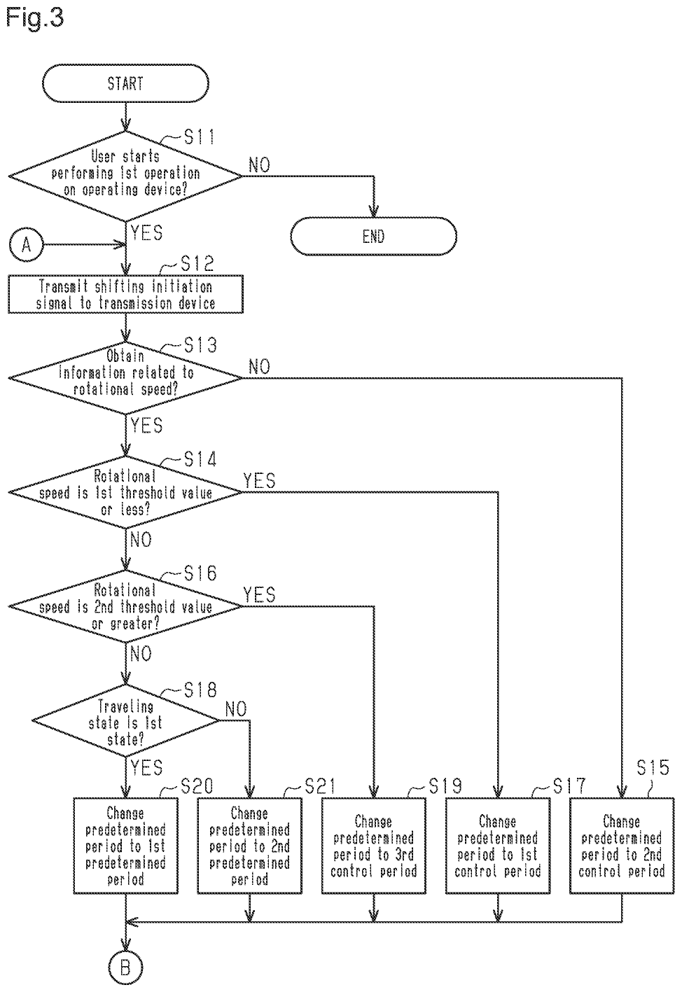

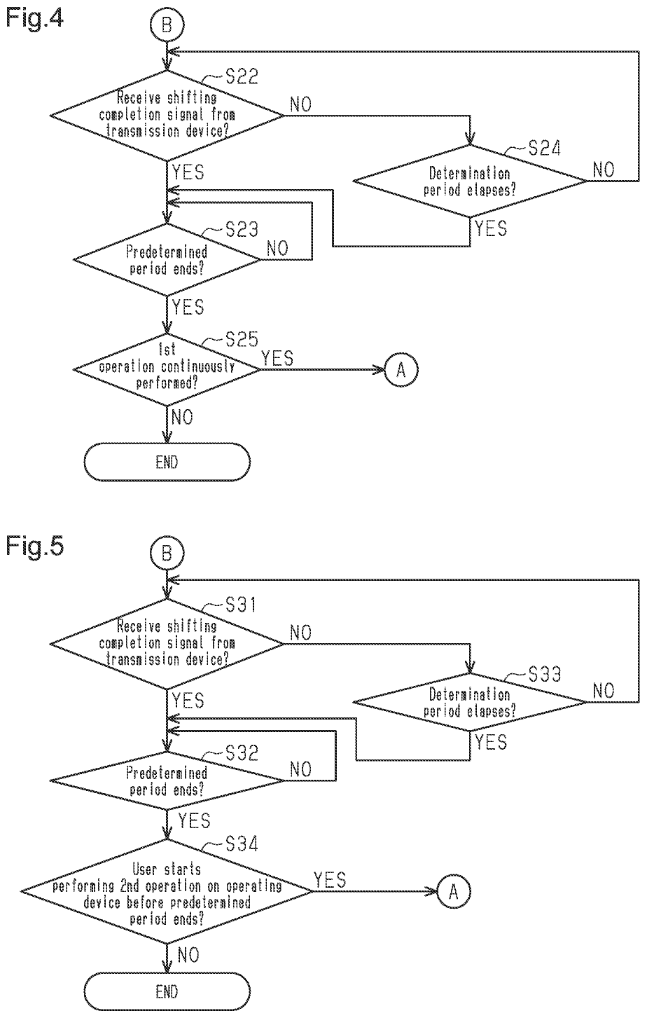

A process executed by the controller 62 to change the predetermined period Y will now be described with reference to FIGS. 3 and 4. In an example in which electric power is supplied to the controller 62, the controller 62 starts the process from step S11 of the flowchart shown in FIG. 3. In a case where the process of the flowchart shown in FIGS. 3 and 4 ends, the controller 62 repeats the process from step S11 of FIG. 3 in predetermined cycles until, for example, the supply of electric power is stopped.

In step S11, the controller 62 determines whether a user starts performing a first operation on the operating device 44. In an example in which the controller 62 receives a signal related to operation of the operating device 44 from the operating device 44, the controller 62 determines that the user has started performing the first operation on the operating device 44. In a case where the user started performing the first operation on the operating device 44 in step S11, the controller 62 proceeds to step S12. In a case where the user does not start performing the first operation on the operating device 44 in step S11, the controller 62 ends processing.

In step S12, the controller 62 transmits a shifting initiation signal to the transmission device 42 and then proceeds to step S13. In step S13, the controller 62 determines whether information related to the rotational speed C is obtained. In an example in which the controller 62 receives a detection signal from the crank rotational state detector, the controller 62 determines that information related to the rotational speed C has been obtained. In a case where the controller 62 obtains information related to the rotational speed C in step S13, the controller 62 proceeds to step S14. In a case where the controller 62 does not obtain information related to the rotational speed C in step S13, the controller 62 proceeds to step S15. In step S15, the controller 62 changes the predetermined period Y to the second control period and then proceeds to step S22.

In step S14, the controller 62 determines whether the rotational speed C is less than or equal to the first threshold value. In a case where the rotational speed C is greater than the first threshold value in step S14, the controller 62 proceeds to step S16. In a case where the rotational speed C is less than or equal to the first threshold value in step S14, the controller 62 proceeds to step S17. In step S17, the controller 62 changes the predetermined period Y to the first control period and then proceeds to step S22.

In step S16, the controller 62 determines whether the rotational speed C is greater than or equal to the second threshold value. In a case where the rotational speed C is less than the second threshold value in step S16, the controller 62 proceeds to step S18. In a case where the rotational speed C is greater than or equal to the second threshold value in step S16, the controller 62 proceeds to step S19. In step S19, the controller 62 changes the predetermined period Y to the third control period and then proceeds to step S22.

In step S18, the controller 62 determines whether the traveling state is the first state. In a case where the traveling state is not the first state, the traveling state is, for example, the second state. In a case where the traveling state is the first state, the controller 62 proceeds to step S20. In step S20, the controller 62 changes the predetermined period Y to the first predetermined period and then proceeds to step S22. In a case where the traveling state is the second state, the controller 62 proceeds to step S21. In step S21, the controller 62 changes the predetermined period Y to the second predetermined period and then proceeds to step S22.

In step S22, the controller 62 determines whether a shifting completion signal is received from the transmission device 42. In a case where the controller 62 receives a shifting completion signal from the transmission device 42, the controller 62 proceeds to step S23. In a case where the controller 62 does not receive a shifting completion signal from the transmission device 42, the controller 62 proceeds to step S24. In step S24, the controller 62 determines whether a determination period elapses. The determination period includes, for example, a period required by the transmission device 42 to complete an action after the shifting initiation signal is transmitted. In a case where the determination period has elapsed, the controller 62 proceeds to step S23. In a case where the determination period does not elapse, the controller 62 returns to step S22 and repeats the process from step S22. In a case where the determination period elapsed in step S24, the controller 62 can end the process without proceeding to step S23.

In step S23, the controller 62 determines whether the predetermined period Y ends. The controller 62 repeats step S23 until the predetermined period Y ends. In a case where the predetermined period has ended, the controller 62 proceeds to step S25. In step S25, the controller 62 determines whether the first operation is continuously performed. In an example in which the controller 62 is continuously receiving a signal related to operation of the operating device 44 from the operating device 44 after the predetermined period Y ended, the controller 62 determines that the first operation has been continuously performed. In a case where the first operation is continuously performed, the controller 62 proceeds to step S12. In a case where the first operation is not continuously performed, the controller 62 ends processing.

The length of time required for an action of the transmission device 42 varies in accordance with the traveling state. If measurement of the period during which actuation of the transmission device 42 is restricted is started as the transmission device 42 initiates an action or while the transmission device 42 is performing an action, the period would be unnecessarily prolonged taking into consideration the time required for the action of the transmission device 42. The controller 62 of the present embodiment starts measuring the predetermined period Y, during which actuation of the transmission device 42 is restricted, from the first time after the action of the transmission device 42 is completed. This avoids a situation in which the time required for performing an action of the transmission device 42 causes the predetermined period Y to become an inappropriate length.

### Second Embodiment

A human-powered vehicle control device 60, a human-powered vehicle component 48, and a human-powered vehicle drive unit 46 in accordance with a second embodiment will now be described with reference to FIGS. 3 to 5. Same reference numerals are given to those components in the human-powered vehicle control device 60, the human-powered vehicle component 48, and the human-powered vehicle drive unit 46 in accordance with the second embodiment that are the same as the corresponding components of the first embodiment. Such components will not be described in detail.

The controller 62 of the second embodiment is configured to control the transmission device 42 so that the transmission device 42 initiates a following action as the predetermined period Y ends in a case where a user starts performing a second operation on the operating device 44 after ending the first operation and before the predetermined period Y ends. The second operation can be the same as or differ from the first operation performed by the user. The first and second operations are each, for example, a short-press. A short-press is an operation performed for a predetermined operation period or less. The controller 62 determines that a number of operations are consecutively performed in a case where the second operation is started after the first operation is ended and before the predetermined period Y ends.

A process executed by the controller 62 of the second embodiment to change the predetermined period Y will now be described with reference to FIGS. 3 and 5. In an example in which electric power is supplied to the controller 62, the controller 62 starts the process from step S11 of the flowchart shown in FIG. 3.

After the process of steps S11 to S21 shown in FIG. 3, the controller 62 of the second embodiment executes steps S31 to S34 shown in FIG. 5 instead of steps S22 to S25 shown in FIG. 4. In a case where the process of the flowchart shown in FIGS. 3 and 5 ends, the controller 62 repeats the process from step S11 of FIG. 3 in predetermined cycles until, for example, the supply of electric power is stopped.

In steps S31 to S33 of FIG. 5, the controller 62 executes the same process as steps S22 to S24 of FIG. 4. The controller 62 repeats step S32 until the predetermined period Y ends. In a case where the predetermined period Y ends in step S32, the controller 62 proceeds to step S34.

In step S34, the controller 62 determines whether the user started performing the second operation on the operating device 44 before the predetermined period Y ended. In a case where the second operation is started during steps S11 to S32, the controller 62 turns on a flag. In a case where the flag is on in step S34, the controller 62 determines that the second operation has been started before the predetermined period Y ended. In a case where the second operation is started before the predetermined period Y ended, the controller 62 proceeds to step S12. In a case where the second operation is not started, the controller 62 ends processing.

### Modifications

The description related with the above embodiments exemplifies, without any intention to limit, applicable forms of a control device for a human-powered vehicle, a component for a human-powered vehicle, and a drive unit for a human-powered vehicle in accordance with the present disclosure. In addition to the embodiments described above, the control device for a human-powered vehicle, the component for a human-powered vehicle, and the drive unit for a human-powered vehicle according to the present disclosure are applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

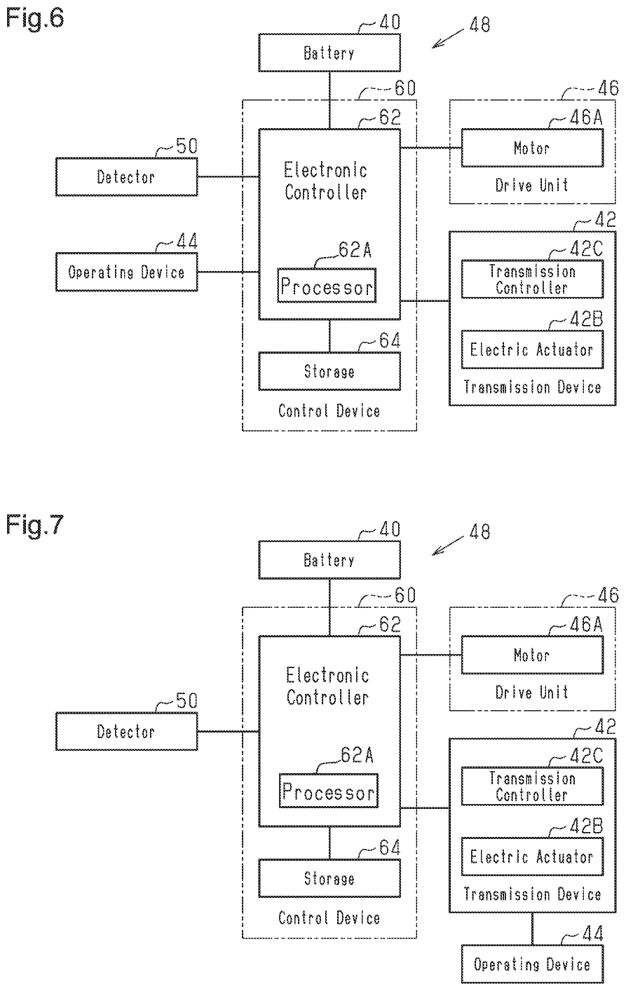

As shown in FIG. 6, in a case where the control device 60 is provided separately from the transmission device 42, the control device 60 can be provided on any member of the human-powered vehicle 10 rather than the drive unit 46. Further, the control device 60 can be provided on an external device outside the human-powered vehicle 10.

As shown in FIG. 7, in a case where the control device 60 is provided separately from the transmission device 42, the operating device 44 can be electrically connected to the transmission device 42 without the controller 62. In a case where the operating device 44 is electrically connected to the transmission device 42 without the controller 62, the controller 62 is configured to receive information related to operation of the operating device 44 from, for example, the transmission device 42.

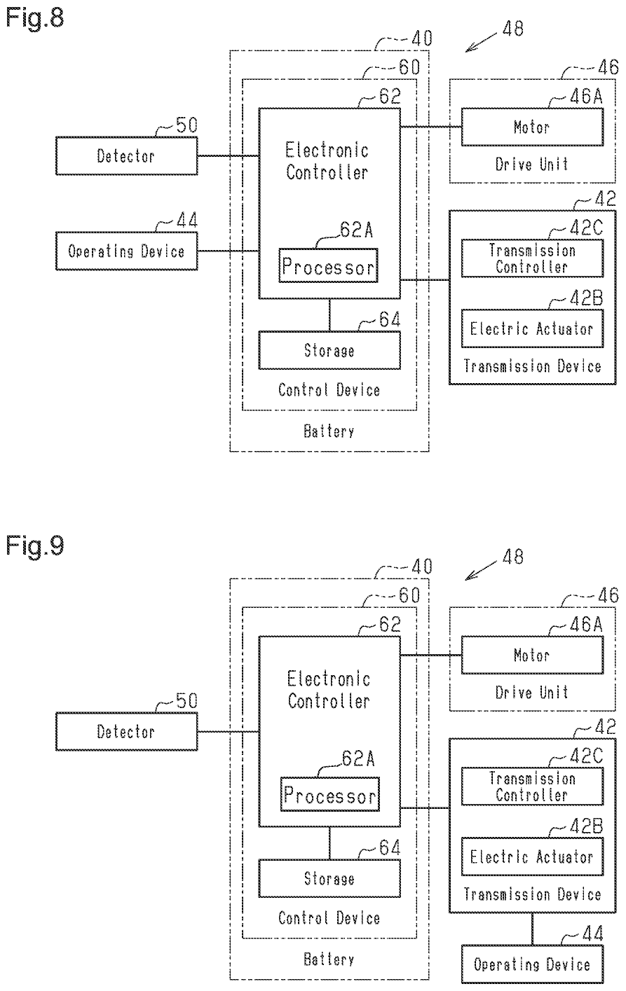

As shown in FIG. 8, in a case where the control device 60 is provided separately from the transmission device 42, the component 48 can include, for example, the battery 40 and the control device 60. In a case where the component 48 includes the battery 40 and the control device 60, the control device 60 can be provided on the battery 40.

As shown in FIG. 9, in a case where the control device 60 is provided on the battery 40, the operating device 44 can be electrically connected to the transmission device 42 without the controller 62. In a case where the operating device 44 is electrically connected to the transmission device 42 without the controller 62, the controller 62 is configured to receive information related to operation of the operating device 44 from, for example, the transmission device 42.

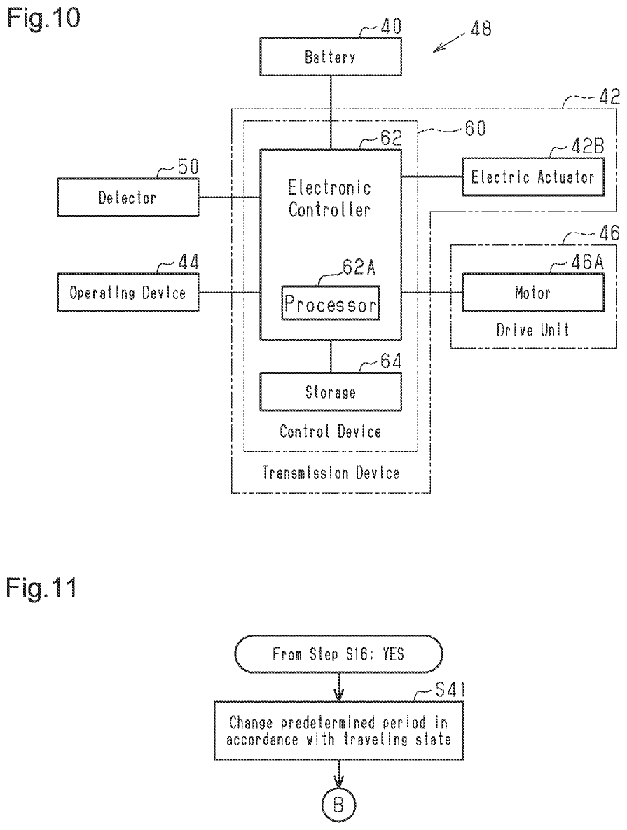

As shown in FIG. 10, the human-powered vehicle component 48 can include the control device 60 and the transmission device 42. In a case where the component 48 includes the control device 60 and the transmission device 42, the control device 60 can be provided on the transmission device 42. In the modified example shown in FIG. 10, the drive unit 46 can be omitted from the human-powered vehicle 10. In a case where the control device 60 is provided on the transmission device 42, the transmission controller 42C can be included in the controller 62. Alternatively, the transmission controller 42C can be provided on the transmission device 42 separately from the controller 62.

As shown in FIG. 11, in a case where the rotational speed C of the crank 18 is less than the second threshold value in step S16, the controller 62 can proceed to step S41. In step S41, the controller 62 changes the predetermined period Y in accordance with the traveling state. In step S41, the controller 62 determines the predetermined period Y using the traveling state and setting information stored in advance in the storage 64. The setting information includes, for example, at least one of a table, a map, and a relational expression that associates the traveling state with the predetermined period Y. The relational expression can include expression (2). In a case where the controller 62 completes the process of step S41, the controller 62 proceeds to step S22.

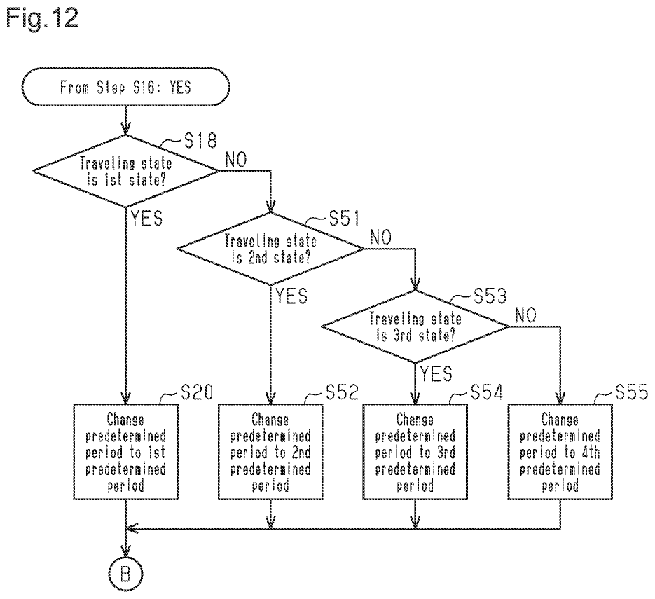

The traveling state can include three or more traveling states. In a case where the traveling state includes three or more traveling states, the traveling state can include a third state in addition to the first and second states. In a case where the traveling state includes three or more traveling states, a predetermined period can be set for each of the traveling states. In a case where the traveling state includes three or more traveling states, the traveling state can include a fourth state in addition to the first to third states. The controller 62 can be configured to change the predetermined period Y so that the predetermined period Y becomes a third predetermined period in a case where the traveling state is the third state. For example, the third predetermined period differs from both the first and second predetermined periods. The controller 62 can be configured to change the predetermined period Y so that the predetermined period Y becomes a fourth predetermined period in a case where the traveling state is the fourth state. For example, the fourth predetermined period differs from every one of the first to third predetermined periods. In a case where the traveling state includes three or more traveling states, the controller 62 can determine which one of the traveling states is the traveling state in step S18 and then proceed to a process for changing the predetermined period Y in accordance with the traveling state. In a case where the traveling state includes first to fourth traveling states, the controller 62 can execute the process illustrated in FIG. 12.

As shown in FIG. 12, in a case where the traveling state is not the first traveling state in step S18, the controller 62 proceeds to step S51.

In step S51, the controller 62 determines whether the traveling state is the second state. In a case where the traveling state is the second traveling state in step S51, the controller 62 proceeds to step S52.

In step S52, the controller 62 changes the predetermined period Y to the second predetermined period and then proceeds to step S22. In a case where the traveling state is not the second traveling state in step S51, the controller 62 proceeds to step S53.

In step S53, the controller 62 determines whether the traveling state is the third state. In a case where the traveling state is the third state, the controller 62 proceeds to step S54.

In step S54, the controller 62 changes the predetermined period Y to the third predetermined period and then proceeds to step S22. In a case where the traveling state is not the third traveling state in step S53, the controller 62 proceeds to step S55. In a case where the traveling state is not the first to third states in step S53, the traveling state is the fourth state.

In step S55, the controller 62 changes the predetermined period Y to the fourth predetermined period and then proceeds to step S22.

The controller 62 can change the predetermined period Y in accordance with the vehicle speed instead of or in addition to the rotational speed C of the crank 18. The vehicle speed in the first state includes, for example, a first vehicle speed. The vehicle speed in the second state includes, for example, a second vehicle speed. The controller 62 is, for example, configured to change the predetermined period Y so that the first predetermined period becomes longer than the second predetermined period in a case where the first vehicle speed is less than the second vehicle speed. The controller 62 can be, for example, configured to change the predetermined period Y so that the first predetermined period becomes shorter than the second predetermined period in a case where the first vehicle speed is greater than the second vehicle speed.

The controller 62 can be configured to control the transmission device 42 so that the transmission device 42 is actuated in accordance with at least one of the traveling state and a traveling environment of the human-powered vehicle 10. For example, the controller 62 controls the transmission device 42 so as to maintain at least one of the rotational speed C of the crank 18 and the human driving force within a predetermined range. The controller 62 changes the predetermined period Y in accordance with the traveling state in a case where the controller 62 controls the transmission device 42 to change the transmission ratio R in multiple stages in accordance with at least one of the traveling state and the traveling environment of the human-powered vehicle 10.

In the second embodiment, the controller 62 can control the transmission device 42 so that the transmission device 42 executes an action for a number of times that is equal to the number of operations performed on the operating device 44 in a case where an operation is performed a number of times by the user on the operating device 44 before the predetermined period Y ends. In an example in which a predetermined number of operations, each corresponding to transmission shift up, are performed on the operating device 44, the controller 62 controls the transmission device 42 so that the transmission device 42 executes an action corresponding to transmission shift up for the predetermined number of times. In an example in which a predetermined number of operations, each corresponding to transmission shift down, are performed on the operating device 44, the controller 62 controls the transmission device 42 so that the transmission device 42 executes an action corresponding to transmission shift down for the predetermined number of times. In an example in which the controller 62 controls the transmission device 42 so that the transmission device 42 performs an action for a number of times that is equal to the number of operations performed on the operating device 44, the controller 62 sets the predetermined period Y for each action of the transmission device 42. In a case where the controller 62 controls the transmission device 42 so that the transmission device 42 performs an action for a number of times that is equal to the number of operations performed on the operating device 44, the controller 62 initiates a following action of the transmission device 42 as the predetermined period Y elapses after one action of the transmission device 42 is completed.

In the second embodiment, the controller 62 can determine that the operating portion of the operating device 44 has been performed from a change in a signal of the operating portion of the operating device 44. In an example in which the operating portion of the operating device 44 includes an electric switch configured to change a signal from low to high in a case where the electric switch is operated, the controller 62 determines that the operating portion of the operating device 44 has been performed if the signal from the operating device 44 changes from low to high. In a case where the controller 62 determines from a change in the signal of the operating portion of the operating device 44 that the operating device 44 has been operated, if the signal continues to be high after the predetermined period Y elapses, the controller 62 can be configured not to perform the determination of whether the second operation has been performed and not to have the transmission device 42 perform the following action.

The first embodiment can be combined with the second embodiment. The controller 62 can combine, for example, a control executed in a case where a long-press is performed on the operating device 44 with a control executed in a case where a short-press is performed on the operating device 44. The controller 62 controls the transmission device 42 so that the transmission device 42 repeats an action twice in an example in which a user temporarily stops operating the operating device 44 and then starts operating the operating device 44 again before the predetermined period Y ends so that the user is continuously operating the operating device 44 at the end of the predetermined period Y.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

What is claimed is:

1. A control device for controlling a transmission device of a human-powered vehicle, the control device comprising:
an electronic controller configured to control the transmission device,
the controller being configured to restrict actuation of the transmission device for a predetermined period from a first time after an action of the transmission device is completed, and
the electronic controller is configured to change the predetermined period in accordance with a traveling state of the human-powered vehicle.

2. The control device according to claim 1, wherein
the electronic controller is configured to change the predetermined period in accordance with the traveling state at a second time that is between initiation of an action of the transmission device and completion of the action.

3. The control device according to claim 1, wherein:
the traveling state includes a first state and a second state that differs from the first state;
the electronic controller is configured to change the predetermined period so that the predetermined period becomes a first predetermined period in a case where the traveling state is the first state;
the electronic controller is configured to change the predetermined period so that the predetermined period becomes a second predetermined period in a case where the traveling state is the second state; and
the first predetermined period is longer than the second predetermined period.

4. The control device according to claim 3, wherein:
the traveling state includes a rotational speed of a crank;
the rotational speed of the crank in the first state includes a first crank rotational speed;
the rotational speed of the crank in the second state includes a second crank rotational speed; and
the electronic controller is configured to change the predetermined period so that the first predetermined period becomes longer than the second predetermined period in a case where the first crank rotational speed is less than the second crank rotational speed.

5. The control device according to claim 4, wherein:
the electronic controller is configured to change the predetermined period to a first control period in a case where the rotational speed of the crank is less than or equal to a first threshold value; and
the first control period is a fixed period regardless of the rotational speed of the crank.

6. The control device according to claim 5, wherein
the electronic controller is configured to change the predetermined period to a second control period in a case where the electronic controller does not obtain information related to the rotational speed of the crank.

7. The control device according to claim 6, wherein
the second control period is equal to the first control period.

8. The control device according to claim 4, wherein:
the electronic controller is configured to change the predetermined period to a third control period in a case where the rotational speed of the crank is greater than or equal to a second threshold value; and
the third control period is a fixed period regardless of the rotational speed of the crank.

9. The control device according to claim 3, wherein:
the traveling state includes a rotational speed of a crank and a transmission ratio;
the rotational speed of the crank in the first state includes a first crank rotational speed, and the transmission ratio in the first state includes a first transmission ratio;
the rotational speed of the crank in the second state includes a second crank rotational speed, and the transmission ratio in the second state includes a second transmission ratio; and
the electronic controller is configured to change the predetermined period so that the first predetermined period becomes longer than the second predetermined period in a case where the first transmission ratio is equal to the second transmission ratio and the first crank rotational speed is less than the second crank rotational speed.

10. The control device according to claim 3, wherein:
the traveling state includes a rotational speed of a crank and a transmission stage number;
the rotational speed of the crank in the first state includes a first crank rotational speed, and the transmission stage number in the first state includes a first transmission stage number;
the rotational speed of the crank in the second state includes a second crank rotational speed, and the transmission stage number in the second state includes a second transmission stage number; and
the electronic controller is configured to change the predetermined period so that the first predetermined period becomes longer than the second predetermined period in a case where the first transmission stage number is equal to the second transmission stage number and the first crank rotational speed is less than the second crank rotational speed.

11. The control device according to claim 1, wherein
the traveling state includes at least one of rotational speed of a crank, human torque input to the crank, force input to a pedal, transmission ratio, transmission stage number, and vehicle speed.

12. The control device according to claim 1, wherein
the action of the transmission device includes an action shifting a chain between two adjacent ones of a plurality of sprockets.

13. The control device according to claim 1, wherein
the first time is a time point at which the action of the transmission device is completed.

14. The control device according to claim 1, further comprising:
a receiver configured to receive a shifting completion signal from the transmission device,
the first time being a time point at which the shifting completion signal is received.

15. The control device according to claim 1, wherein
the electronic controller is configured to control the transmission device so that the transmission device is actuated in accordance with an operation performed by a user on an operating device that is operated by the user.

16. The control device according to claim 15, wherein:
the electronic controller is configured to control the transmission device so that the transmission device initiates an action as the user starts performing a first operation on the operating device; and
the electronic controller is configured to control the transmission device so that the transmission device initiates a following action in a case where the first operation is continuously performed as the predetermined period ends.

17. The control device according to claim 15, wherein:
the electronic controller is configured to control the transmission device so that the transmission device initiates an action as the user starts performing a first operation on the operating device; and
the electronic controller is configured to control the transmission device so that the transmission device initiates a following action as the predetermined period ends in a case where the user starts performing a second operation on the operating device after ending the first operation and before the predetermined period ends.

18. The control device according to claim 1, wherein
the control device is provided separately from the transmission device.

19. A human-powered vehicle component comprising the control device according to claim 1, the human-powered vehicle component further comprising:
the transmission device.

20. A human-powered vehicle drive unit comprising the control device according to claim 1, the drive unit further comprising:
a motor configured to apply a propulsion force to the human-powered vehicle.
